(19) United States
(12) Patent Application Publication
(10) Pub. No.: US 2018/0089226 A1
(43) Pub. Date: Mar. 29, 2018

(54) Virtual File System Supporting Multi-Tiered Storage

(71) Applicant: Weka.IO LTD, Tel Aviv (IL)

(72) Inventors: Maor Ben Dayan, Tel Aviv (IL); Omri Palmon, Tel Aviv (IL); Liran Zvibel, Tel Aviv (IL)

(21) Appl. No.: 15/823,638

(22) Filed: Nov. 28, 2017

Related U.S. Application Data
(63) Continuation of application No. 14/789,422, filed on Jul. 1, 2015, now abandoned.

(51) Int. Cl. G06F 17/30; H04L 29/08

(52) U.S. Cl. CPC G06F 17/30233; H04L 67/1097

(57) ABSTRACT

A plurality of computing devices are interconnected via a local area network and comprise circuitry configured to implement a virtual file system comprising one or more instances of a virtual file system front end and one or more instances of a virtual file system back end. Each instance of the virtual file system front end may be configured to receive a file system call from a file system driver residing on the plurality of computing devices, and determine which of the one or more instances of the virtual file system back end is responsible for servicing the file system call. Each instance of the virtual file system back end may be configured to receive a file system call from the one or more instances of the virtual file system front end, and update file system metadata for data affected by the servicing of the file system call.

### BACKGROUND

Limitations and disadvantages of conventional approaches to data storage will become apparent to one of skill in the art, through comparison of such approaches with some aspects of the present method and system set forth in the remainder of this disclosure with reference to the drawings.

### BRIEF SUMMARY

Methods and systems are provided for a virtual file system supporting multi-tiered storage, substantially as illustrated by and/or described in connection with at least one of the figures, as set forth more completely in the claims.

### BRIEF DESCRIPTION OF THE DRAWINGS

FIG. 1 illustrates various example configurations of a virtual file system in accordance with aspects of this disclosure.

FIG. 2 illustrates various example configurations of a compute node that uses a virtual file system in accordance with aspects of this disclosure.

FIG. 3 illustrates various example configurations of a dedicated virtual file system node in accordance with aspects of this disclosure.

FIG. 4 illustrates various example configurations of a dedicated storage node in accordance with aspects of this disclosure.

FIG. 5 is a flowchart illustrating an example method for writing data to a virtual file system in accordance with aspects of this disclosure.

FIG. 6 is a flowchart illustrating an example method for reading data to a virtual file system in accordance with aspects of this disclosure.

FIG. 7 is a flowchart illustrating an example method for using multiple tiers of storage in accordance with aspects of this disclosure.

FIGS. 8A-8E illustrate various example configurations of a virtual file system in accordance with aspects of this disclosure.

FIG. 9 is a block diagram illustrating configuration of a virtual file system from a non-transitory machine-readable storage.

### DETAILED DESCRIPTION

There currently exist many data storage options. One way to classify the myriad storage options is whether they are electronically addressed or (electro)mechanically addressed. Examples of electronically addressed storage options include NAND FLASH, FeRAM, PRAM, MRAM, and memristors. Examples of mechanically addressed storage options include hard disk drives (HDDs), optical drives, and tape drives. Furthermore, there are seemingly countless variations of each of these examples (e.g., SLC and TLC for flash, CDROM and DVD for optical storage, etc.) In any event, the various storage options provide various performance levels at various price points. A tiered storage scheme in which different storage options correspond to different tiers takes advantage of this by storing data to the tier that is determined most appropriate for that data. The various tiers may be classified by any one or more of a variety of factors such as read and/or write latency, IOPS, throughput, endurance, cost per quantum of data stored, data error rate, and/or device failure rate.

Various example implementations of this disclosure are described with reference to, for example, four tiers:

Tier 1—Storage that provides relatively low latency and relatively high endurance (i.e., number of writes before failure). Example memory which may be used for this tier include NAND FLASH, PRAM, and memristors. Tier 1 memory may be either direct attached (DAS) to the same nodes that VFS code runs on, or may be network attached. Direct attachment may be via SAS/SATA, PCI-e, JEDEC DIMM, and/or the like. Network attachment may be Ethernet based, RDMA based, and/or the like. When network attached, the tier 1 memory may, for example, reside in a dedicate storage node. Tier 1 may be byte addressable or block-addressable storage. In an example implementation, data may be stored to Tier 1 storage in “chunks” consisting of one or more “blocks” (e.g., 128 MB chunks comprising 4 kB blocks).

Tier 2—Storage that provides higher latency and/or lower endurance than tier 1. As such, it will typically leverage cheaper memory than tier 1. For example, tier 1 may comprise a plurality of first flash ICs and tier 2 may comprise a plurality of second flash ICs, where the first flash ICs provide lower latency and/or higher endurance than the second flash ICs at a correspondingly higher price. Tier 2 may be DAS or network attached, the same as described above with respect to tier 1. Tier 2 may be file-based or block-based storage.

Tier 3—Storage that provides higher latency and/or lower endurance than tier 2. As such, it will typically leverage cheaper memory than tiers 1 and 2. For example, tier 3 may comprise hard disk drives while tiers 1 and 2 comprise flash. Tier 3 may be object-based storage or a file based network attached storage (NAS). Tier 3 storage may be on premises accessed via a local area network, or may be a cloud-based accessed via the internet. On-premises tier 3 storage may, for example, reside in a dedicated object store node (e.g., provided by Scality or Cleversafe or a custom-built Ceph-based system) and/or in a compute node where it shares resources with other software and/or storage. Example cloud-based storage services for tier 3 include Amazon S3, Microsoft Azure, Google Cloud, and Rackspace.

Tier 4—Storage that provides higher latency and/or lower endurance than tier 3. As such, it will typically leverage cheaper memory than tiers 1, 2, and 3. Tier 4 may be object-based storage. Tier 4 may be on-premises accessed via a local network or cloud-based accessed over the Internet. On-premises tier 4 storage may be a very cost-optimized system such as tape drive or optical drive based archiving system. Example cloud-based storage services for tier 4 include Amazon Glacier and Google Nearline.

These four tiers are merely for illustration. Various implementations of this disclosure are compatible with any number and/or types of tiers. Also, as used herein, the phrase “a first tier” is used generically to refer to any tier and does necessarily correspond to Tier 1. Similarly, the phrase “a second tier” is used generically to refer to any tier and does necessarily correspond to Tier 2. That is, reference to “a first tier and a second tier of storage” may refer to Tier N and Tier M, where N and M are integers not equal to each other.

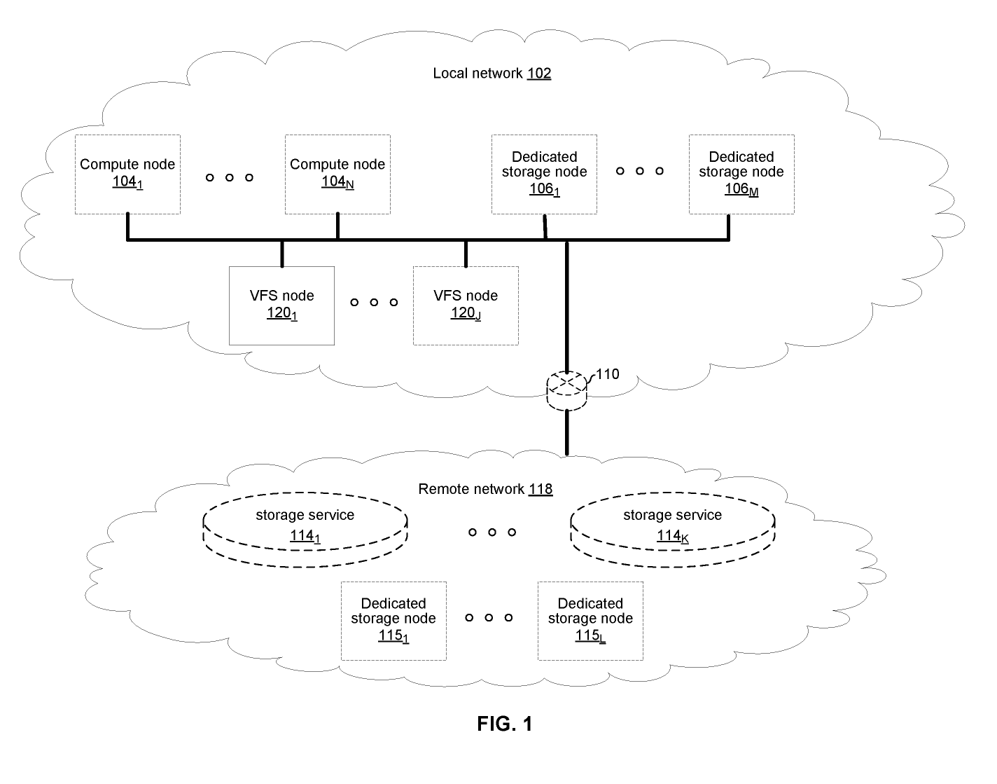

FIG. 1 illustrates various example configurations of a virtual file system in accordance with aspects of this disclosure. Shown in FIG. 1 is a local area network (LAN) 102 comprising one or more virtual file system (VFS) nodes 120 (indexed by integers from 1 to J, for j≧1), and optionally comprising (indicated by dashed lines): one or more dedicated storage nodes 106 (indexed by integers from 1 to M, for M≧1), one or more compute nodes 104 (indexed by integers from 1 to N, for N≧1), and/or an edge router that connects the LAN 102 to a remote network 118. The remote network 118 optionally comprises one or more storage services 114 (indexed by integers from 1 to K, for K≧1), and/or one or more dedicated storage nodes 115 (indexed by integers from 1 to L, for L≧1). Thus, the zero or more tiers of storage may reside in the LAN 102 and zero or more tiers of storage may reside in the remote network 118 and the virtual file system is operable to seamlessly (from the perspective of a client process) manage multiple tiers where some of the tiers are on a local network and some are on a remote network, and where different storage devices of the various tiers have different levels of endurance, latency, total input/output operations per second (IOPS), and cost structures.

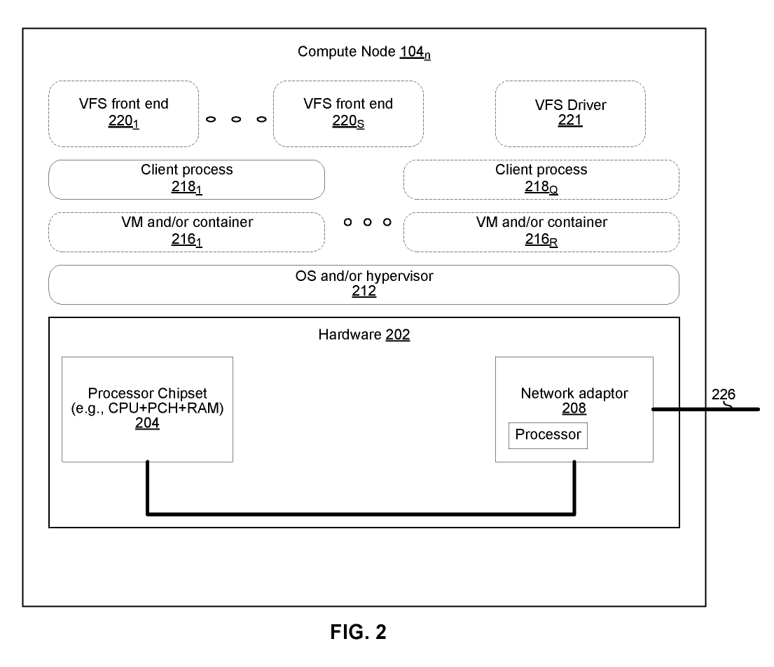

Each compute node 104ₙ (n an integer, where 1≦n≦N) is a networked computing device (e.g., a server, personal computer, or the like) that comprises circuitry for running a variety of client processes (either directly on an operating system of the device 104ₙ and/or in one or more virtual machines/containers running in the device 104ₙ) and for interfacing with one or more VFS nodes 120. As used in this disclosure, a “client process” is a process that reads data from storage and/or writes data to storage in the course of performing its primary function, but whose primary function is not storage-related (i.e., the process is only concerned that its data is reliable stored and retrievable when needed, and not concerned with where, when, or how the data is stored). Example applications which give rise to such processes include: an email server application, a web server application, office productivity applications, customer relationship management (CRM) applications, and enterprise resource planning (ERP) applications, just to name a few. Example configurations of a compute node 104ₙ are described below with reference to FIG. 2.

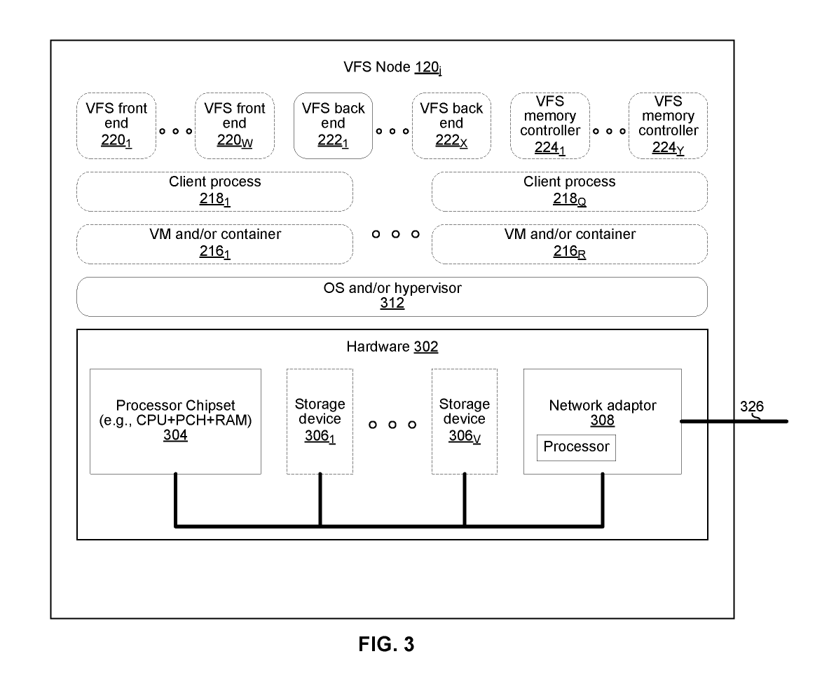

Each VFS node 120ⱼ (j an integer, where 1≦j≦J) is a networked computing device (e.g., a server, personal computer, or the like) that comprises circuitry for running VFS processes and, optionally, client processes (either directly on an operating system of the device 104ₙ and/or in one or more virtual machines running in the device 104ₙ). As used in this disclosure, a “VFS process” is a process that implements one or more of the VFS driver, the VFS front end, the VFS back end, and the VFS memory controller described below in this disclosure. Example configurations of a VFS node 120ⱼ are described below with reference to FIG. 3. Thus, in an example implementation, resources (e.g., processing and memory resources) of the VFS node 120ⱼ may be shared among client processes and VFS processes. The processes of the virtual file system may be configured to demand relatively small amounts of the resources to minimize the impact on the performance of the client applications. From the perspective of the client process(es), the interface with the virtual file system is independent of the particular physical machine(s) on which the VFS process(es) are running.

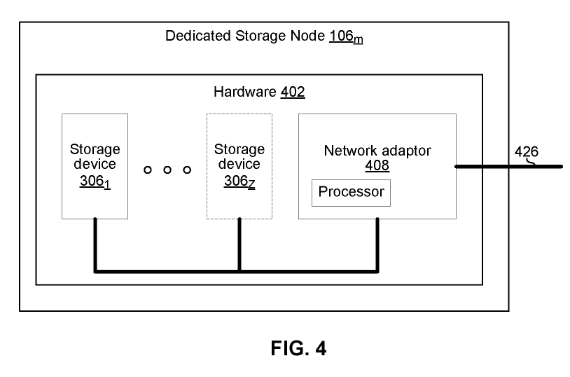

Each on-premises dedicated storage node 106ₘ (m an integer, where 1≦m≦M) is a networked computing device and comprises one or more storage devices and associated circuitry for making the storage device(s) accessible via the LAN 102. The storage device(s) may be of any type(s) suitable for the tier(s) of storage to be provided. An example configuration of a dedicated storage node 106ₘ is described below with reference to FIG. 4.

Each storage service 114ₖ (k an integer, where 1≦k≦K) may be a cloud-based service such as those previously discussed.

Each remote dedicated storage node 115ₗ (1 an integer, where 1≦l≦L) may be similar to, or the same as, an on-premises dedicated storage node 106. In an example implementation, a remote dedicated storage node 115ₗ may store data in a different format and/or be accessed using different protocols than an on-premises dedicated storage node 106 (e.g., HTTP as opposed to Ethernet-based or RDMA-based protocols).

FIG. 2 illustrates various example configurations of a compute node that uses a virtual file system in accordance with aspects of this disclosure. The example compute node 104ₙ comprises hardware 202 that, in turn, comprises a processor chipset 204 and a network adaptor 208.

The processor chipset 204 may comprise, for example, an x86-based chipset comprising a single or multi-core processor system on chip, one or more RAM ICs, and a platform controller hub IC. The chipset 204 may comprise one or more bus adaptors of various types for connecting to other components of hardware 202 (e.g., PCIe, USB, SATA, and/or the like).

The network adaptor 208 may, for example, comprise circuitry for interfacing to an Ethernet-based and/or RDMA-based network. In an example implementation, the network adaptor 208 may comprise a processor (e.g., an ARM-based processor) and one or more of the illustrated software components may run on that processor. The network adaptor 208 interfaces with other members of the LAN 100 via (wired, wireless, or optical) link 226. In an example implementation, the network adaptor 208 may be integrated with the chipset 204.

Software running on the hardware 202 includes at least: an operating system and/or hypervisor 212, one or more client processes 218 (indexed by integers from 1 to Q, for Q≧1) and a VFS driver 221 and/or one or more instances of VFS front end 220. Additional software that may optionally run on the compute node 104ₙ includes: one or more virtual machines (VMs) and/or containers 216 (indexed by integers from 1 to R, for R≧1).

Each client process 218_{q} (q an integer, where 1≦q≦Q) may run directly on an operating system 212 or may run in a virtual machine and/or container 216ᵣ (r an integer, where 1≦r≦R) serviced by the OS and/or hypervisor 212. Each client processes 218 is a process that reads data from storage and/or writes data to storage in the course of performing its primary function, but whose primary function is not storage-related (i.e., the process is only concerned that its data is reliably stored and is retrievable when needed, and not concerned with where, when, or how the data is stored). Example applications which give rise to such processes include: an email server application, a web server application, office productivity applications, customer relationship management (CRM) applications, and enterprise resource planning (ERP) applications, just to name a few.

Each VFS front end instance 220, (s an integer, where 1≦s≦S if at least one front end instance is present on compute node 104ₙ) provides an interface for routing file system requests to an appropriate VFS back end instance (running on a VFS node), where the file system requests may originate from one or more of the client processes 218, one or more of the VMs and/or containers 216, and/or the OS and/or hypervisor 212. Each VFS front end instance 220ₛ may run on the processor of chipset 204 or on the processor of the network adaptor 208. For a multi-core processor of chipset 204, different instances of the VFS front end 220 may run on different cores.

FIG. 3 shows various example configurations of a dedicated virtual file system node in accordance with aspects of this disclosure. The example VFS node 120ⱼ comprises hardware 302 that, in turn, comprises a processor chipset 304, a network adaptor 308, and, optionally, one or more storage devices 306 (indexed by integers from 1 to W, for W≧1).

Each storage device 306ₚ (p an integer, where 1≦p≦P if at least one storage device is present) may comprise any suitable storage device for realizing a tier of storage that it is desired to realize within the VFS node 120ⱼ.

The processor chipset 304 may be similar to the chipset 204 described above with reference to FIG. 2. The network adaptor 308 may be similar to the network adaptor 208 described above with reference to FIG. 2 and may interface with other nodes of LAN 100 via link 326.

Software running on the hardware 302 includes at least: an operating system and/or hypervisor 212, and at least one of: one or more instances of VFS front end 220 (indexed by integers from 1 to W, for W≧1), one or more instances of VFS back end 222 (indexed by integers from 1 to X, for X≧1), and one or more instances of VFS memory controller 224 (indexed by integers from 1 to Y, for Y≧1). Additional software that may optionally run on the hardware 302 includes: one or more virtual machines (VMs) and/or containers 216 (indexed by integers from 1 to R, for R≧1), and/or one or more client processes 318 (indexed by integers from 1 to Q, for Q≧1). Thus, as mentioned above, VFS processes and client processes may share resources on a VFS node and/or may reside on separate nodes.

The client processes 218 and VM(s) and/or container(s) 216 may be as described above with reference to FIG. 2.

Each VFS front end instance 220_{W} (w an integer, where 1≦w≦W if at least one front end instance is present on VFS node 120ⱼ) provides an interface for routing file system requests to an appropriate VFS back end instance (running on the same or a different VFS node), where the file system requests may originate from one or more of the client processes 218, one or more of the VMs and/or containers 216, and/or the OS and/or hypervisor 212. Each VFS front end instance 220_{w} may run on the processor of chipset 304 or on the processor of the network adaptor 308. For a multi-core processor of chipset 304, different instances of the VFS front end 220 may run on different cores.

Each VFS back end instance 222ₓ (x an integer, where 1≦x≦X if at least one back end instance is present on VFS node 120ⱼ) services the file system requests that it receives and carries out tasks to otherwise manage the virtual file system (e.g., load balancing, journaling, maintaining metadata, caching, moving of data between tiers, removing stale data, correcting corrupted data, etc.) Each VFS back end instance 222ₓ may run on the processor of chipset 304 or on the processor of the network adaptor 308. For a multi-core processor of chipset 304, different instances of the VFS back end 222 may run on different cores.

Each VFS memory controller instance 224ᵤ (u an integer, where 1≦u≦U if at least VFS memory controller instance is present on VFS node 120ⱼ) handles interactions with a respective storage device 306 (which may reside in the VFS node 120j or another VFS node 120 or a storage node 106). This may include, for example, translating addresses, and generating the commands that are issued to the storage device (e.g. on a SATA, PCIe, or other suitable bus). Thus, the VFS memory controller instance 224ₙ operates as an intermediary between a storage device and the various VFS back end instances of the virtual file system.

FIG. 4 illustrates various example configurations of a dedicated storage node in accordance with aspects of this disclosure. The example dedicated storage node 106ₘ comprises hardware 402 which, in turn, comprises a network adaptor 408 and at least one storage device 306 (indexed by integers from 1 to Z, for Z≧1). Each storage device 306_{Z} may be the same as storage device 306_{W} described above with reference to FIG. 3. The network adaptor 408 may comprise circuitry (e.g., an arm based processor) and a bus (e.g., SATA, PCIe, or other) adaptor operable to access (read, write, etc.) storage device(s) 406₁-406_{Z} in response to commands received over network link 426. The commands may adhere to a standard protocol. For example, the dedicated storage node 106ₘ may support RDMA based protocols (e.g., Infiniband, RoCE, iWARP etc.) and/or protocols which ride on RDMA (e.g., NVMe over fabrics).

In an example implementation, tier 1 memory is distributed across one or more storage devices 306 (e.g., FLASH devices) residing in one or more storage node(s) 106 and/or one or more VFS node(s) 120. Data written to the VFS is initially stored to Tier 1 memory and then migrated to one or more other tier(s) as dictated by data migration policies, which may be user-defined and/or adaptive based on machine learning.

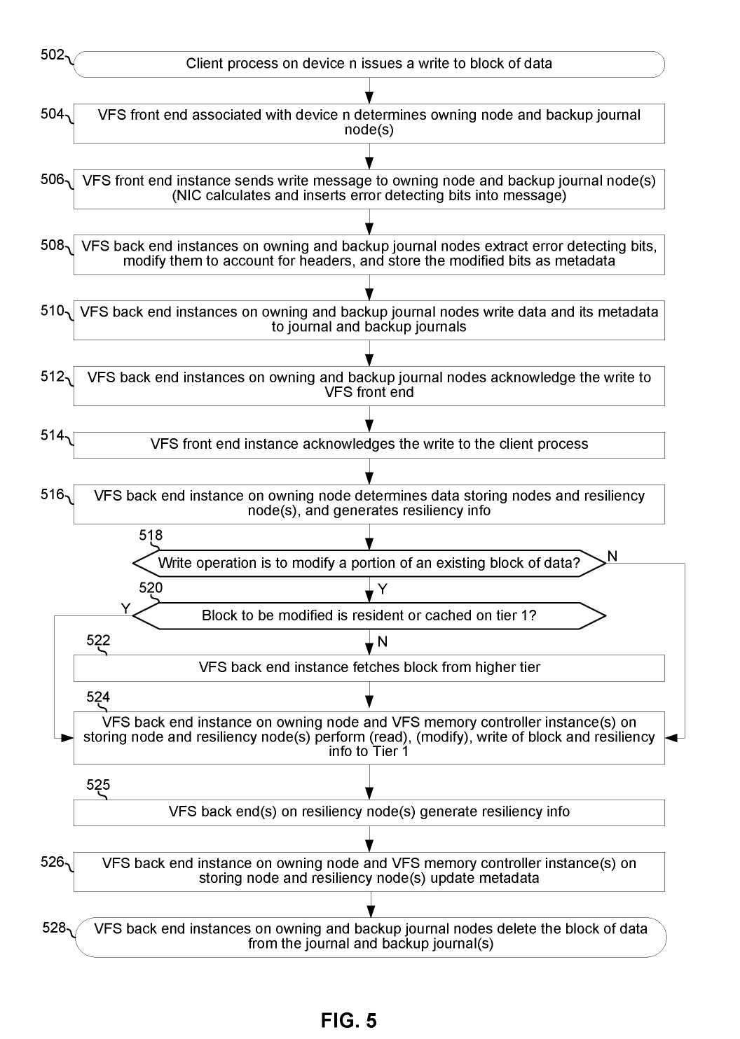

FIG. 5 is a flowchart illustrating an example method for writing data to a virtual file system in accordance with aspects of this disclosure. The method begins in step 502 when a client process running on computing device ‘n’ (may be a compute node 104 or a VFS node 120) issues a command to write block of data.

In step 504, an instance of VFS front end 220 associated with computing device ‘n’ determines the owning node and backup journal node(s) for the block of data. If computing device ‘n’ is a VFS node, the instance of the VFS front end may reside on the same device or another device. If computing device ‘n’ is a compute node, the instance of the VFS front end may reside on another device.

In step 506, the instance of the VFS front end associated with device ‘n’ sends a write message to the owning node and backup journal node(s). The write message may include error detecting bits generated by the network adaptor. For example, the network adaptor may generate an Ethernet frame check sequence (FCS) and insert it into a header of an Ethernet frame that carries the message to the owning node and backup journal node(s), and/or may generate a UDP checksum that it inserts into a UDP datagram that carries the message to the owning node and backup journal nodes.

In step 508, instances of the VFS back end 222 on the owning and backup journal node(s) extract the error detecting bits, modify them to account for headers (i.e., so that they correspond to only the write message), and store the modified bits as metadata.

In step 510, the instances of the VFS back end on the owning and backup journal nodes write the data and metadata to the journal and backup journal(s).

In step 512, the VFS back end instances on the owning and backup journal node(s) acknowledge the write to VFS front end instances associated with device ‘n.’

In step 514, the VFS front end instance associated with device ‘n’ acknowledges the write to the client process.

In step 516, the VFS back end instance on the owning node determines (e.g., via a hash) the devices that are the data storing node and the resiliency node(s) for the block of data.

In step 518, the VFS back end instance on the owning node determines if the block of data is existing data that is to be partially overwritten. If so, the method of FIG. 5 advances to step 520. If not, the method of FIG. 5 advances to step 524.

In step 520, the VFS back end instance on the owning node determines whether the block to be modified is resident or cached on Tier 1 storage. If so, the method of FIG. 5 advances to step 524. If not, the method of FIG. 5 advances to step 522. Regarding caching, which data resident on higher tiers is cached on Tier 1 is determined in accordance with caching algorithms in place. The caching algorithms may, for example, be learning algorithms and/or implement user-defined caching policies. Data that may be cached includes, for example, recently-read data and pre-fetched data (data predicted to be read in the near future).

In step 522, the VFS back end instance on the owning node fetches the block from a higher tier of storage.

In step 524, the VFS back end instance on the owning node and one or more instances of the VFS memory controller 224 on the storing and resiliency nodes read the block, as necessary (e.g., may be unnecessary if the outcome of step 518 was ‘no’ or if the block was already read from higher tier in step 522), modify the block, as necessary (e.g., may be unnecessary if the outcome of step 518 was no), and write the block of data and the resiliency info to Tier 1.

In step 525, the VFS back end instance(s) on the resiliency node(s) generate(s) resiliency information (i.e., information that can be used later, if necessary, for recovering the data after it has been corrupted).

In step 526, the VFS back end instance on the owning node, and the VFS memory controller instance(s) on the storing and resiliency nodes update the metadata for the block of data

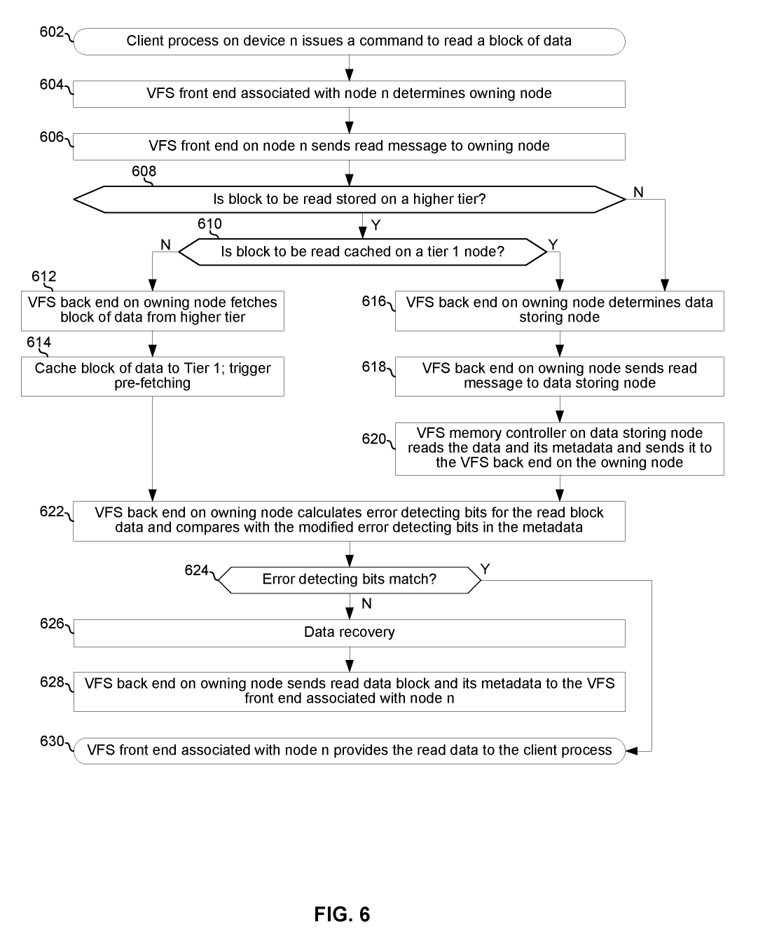

FIG. 6 is a flowchart illustrating an example method for reading data to a virtual file system in accordance with aspects of this disclosure. The method of FIG. 6 begins with step 602 in which a client process running on device ‘n’ issues a command to read a block of data.

In step 604, an instance of VFS front end 220 associated with computing device ‘n’ determines (e.g., based on a hash) the owning node for the block of data. If computing device ‘n’ is a VFS node, the instance of the VFS front end may reside on the same device or another device. If computing device ‘n’ is a compute node, the instance of the VFS front end may reside on another device.

In step 606, the instance of the VFS front end running on node ‘n’ sends a read message to an instance of the VFS back end 222 running on the determined owning node.

In step 608, the VFS back end instance on the owning node determines whether the block of data to be read is stored on a tier other than Tier 1. If not, the method of FIG. 6 advances to step 616. If so, the method of FIG. 6 advances to step 610.

In step 610, the VFS back end instance on the owning node determines whether the block of data is cached on Tier 1 (even though it is stored on a higher tier). If so, then the method of FIG. 6 advances to step 616. If not the method of FIG. 6 advances to step 612.

In step 612, the VFS back end instance on the owning node fetches the block of data from the higher tier.

In step 614, the VFS back end instance on the owning node, having the fetched data in memory, sends a write message to a tier 1 storing node to cache the block of data. The VFS back end may on the owning node may also trigger pre-fetching algorithms which may fetch additional blocks predicted to be read in the near future.

In step 616, the VFS back end instance on the owning node determines the data storing node for the block of data to be read.

In step 618, the VFS back end instance on the owning node sends a read message to the determined data storing node.

In step 620, an instance of the VFS memory controller 224 running on the data storing node reads the block of data and its metadata and returns them to the VFS back end instance on the owning node.

In step 622, the VFS back end on the owning node, having the block of data and its metadata in memory, calculates error detecting bits for the data and compares the result with error detecting bits in the metadata.

In step 624, if the comparison performed in step 614 indicated a match, then the method of FIG. 6 advances to step 630. Otherwise the method of FIG. 6 proceeds to step 626.

In step 626, the VFS back end instance on the owning node retrieves resiliency data for the read block of data and uses it to recover/correct the data.

In step 628, the VFS back end instance on the owning node sends the read block of data and its metadata to the VFS front end associated with device ‘n.’

In step 630, the VFS front end associated with node n provides the read data to the client process.

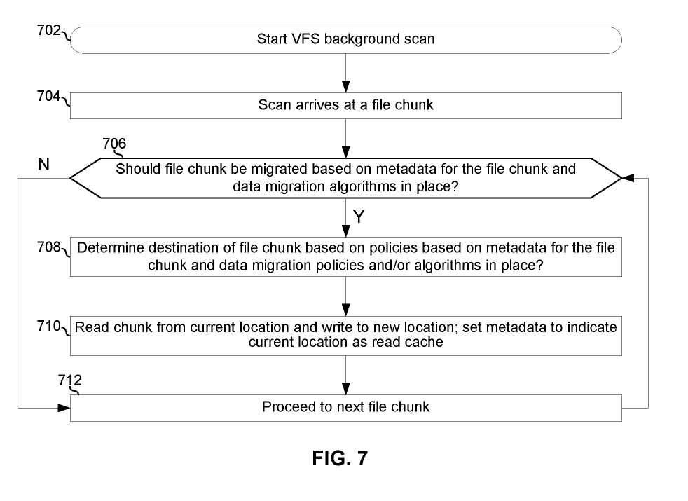

FIG. 7 is a flowchart illustrating an example method for using multiple tiers of storage in accordance with aspects of this disclosure. The method of FIG. 7 begins with step 702 in which an instance of the VFS back end begins a background scan of the data stored in the virtual file system.

In step 704, the scan arrives at a particular chunk of a particular file.

In step 706, the instance of the VFS back end determines whether the particular chunk of the particular file should be migrated to a different tier of storage based on data migration algorithms in place. The data migration algorithms may, for example, be learning algorithms and/or may implement user defined data migration policies. The algorithms may take into account a variety of parameters (one or more of which may be stored in metadata for the particular chunk) such as, for example, time of last access, time of last modification, file type, file name, file size, bandwidth of a network connection, time of day, resources currently available in computing devices implementing the virtual file system, etc. Values of these parameters that do and do not trigger migrations may be learned by the algorithms and/or set by a user/administrator. In an example implementation, a “pin to tier” parameter may enable a user/administrator to “pin” particular data to a particular tier of storage (i.e., prevent the data from being migrated to another tier) regardless of whether other parameters otherwise indicate that the data should be migrated.

If the data should not be migrated, then the method of FIG. 7 advances to step 712. If the data should be migrated, then the method of FIG. 7 advances to step 708.

In step 708, the VFS back end instance determines, based on the data migration algorithms in place, a destination storage device for the particular file chunk to be migrated to.

In block 710, the chunk of data from the current storage device and write to the device determined in step 708. The chunk may remain on the current storage device with the metadata there changed to indicate the data as read cached.

In block 712, the scan continues and arrives at the next file chunk.

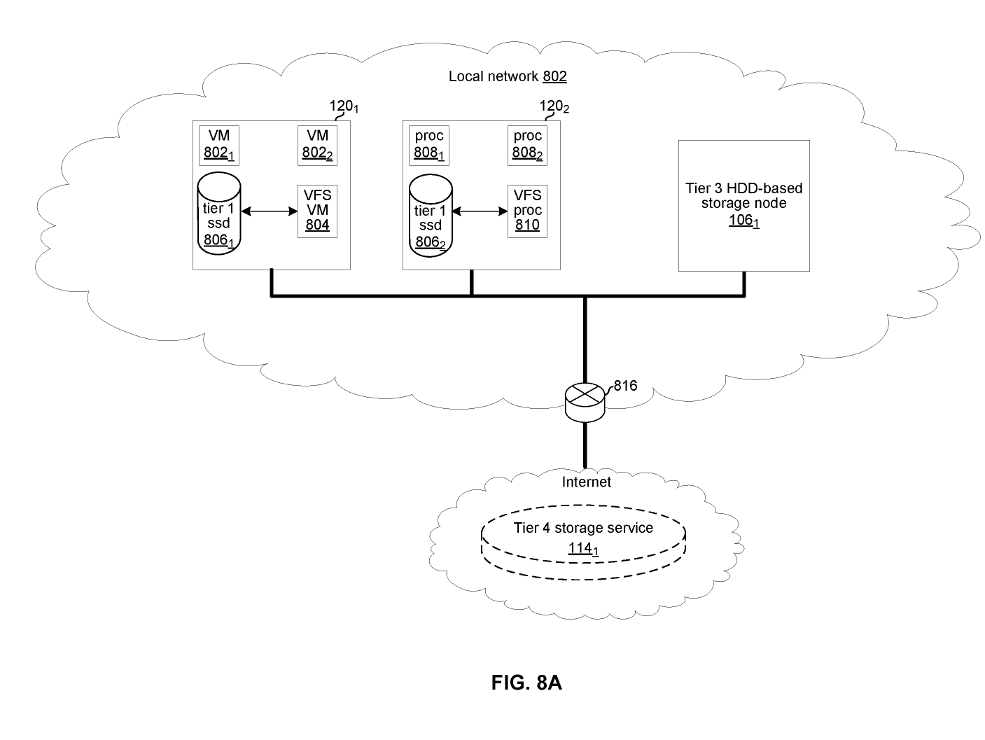

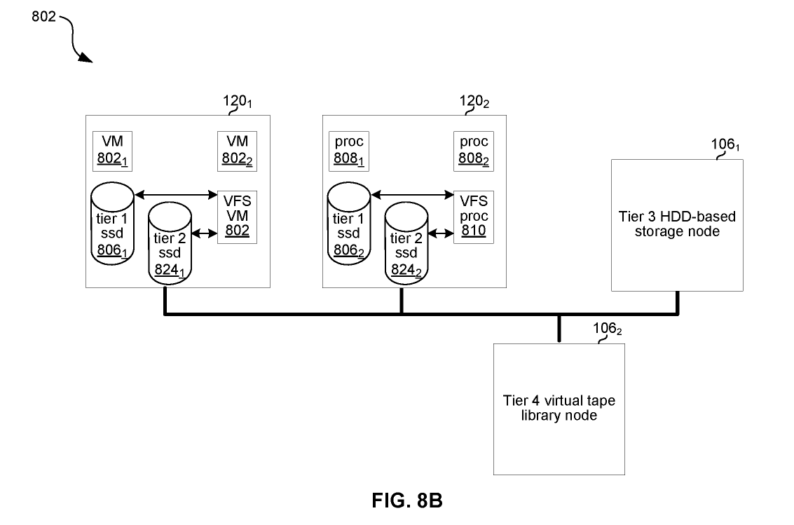

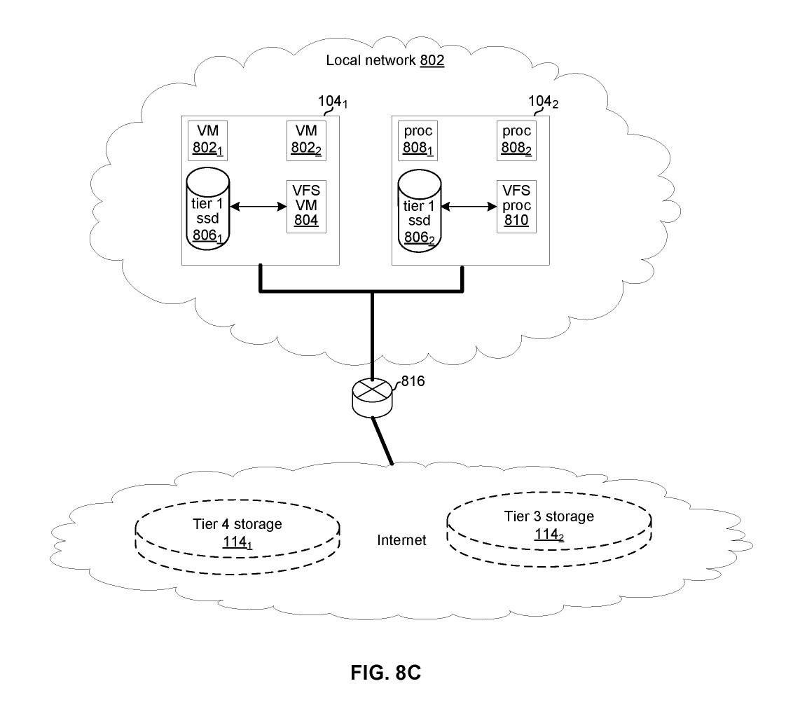

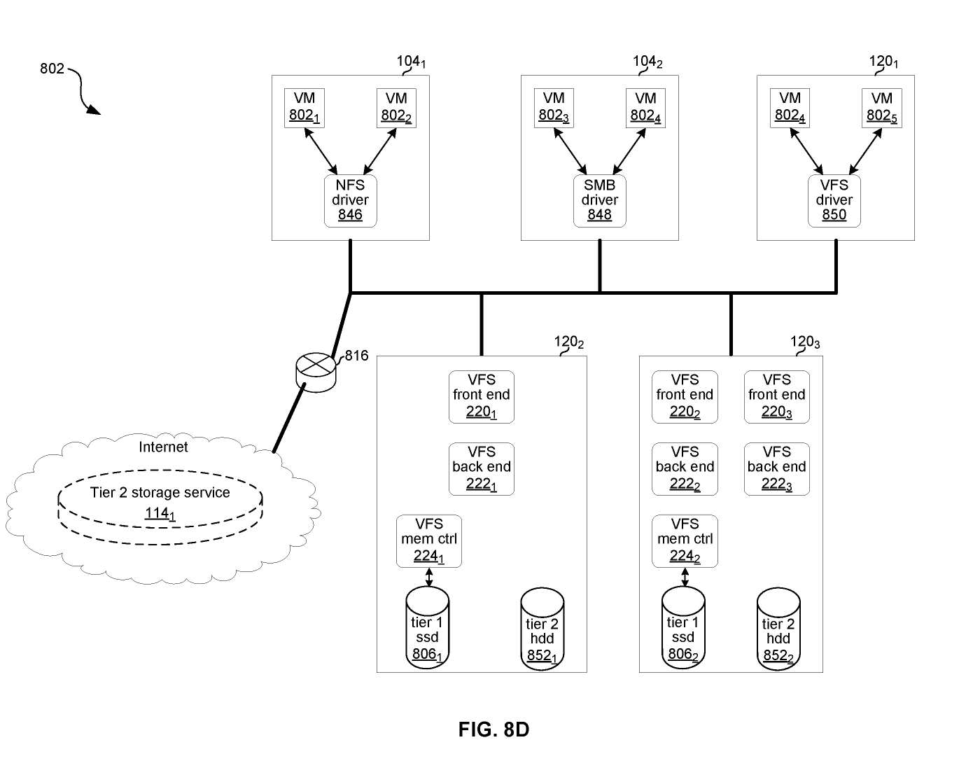

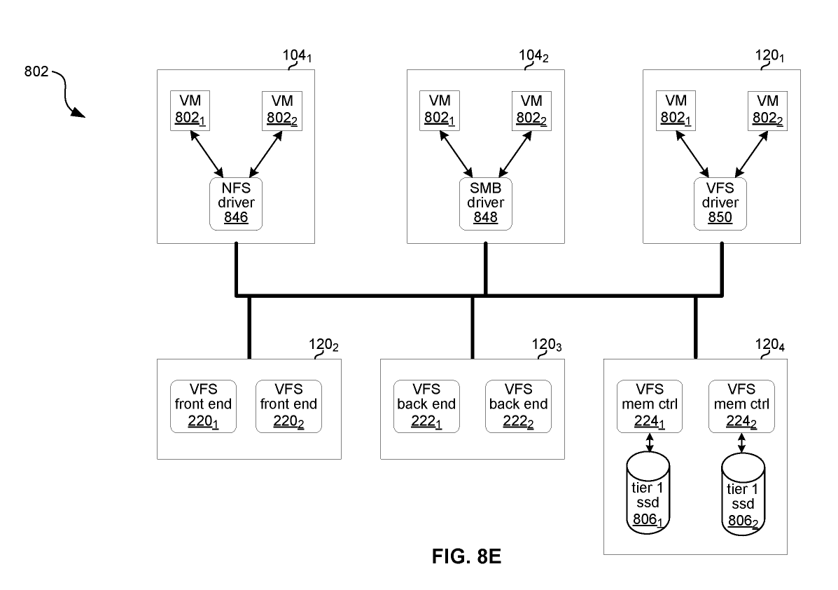

The virtual file system of FIG. 8A is implemented on a plurality of computing devices comprising two VFS nodes 120₁ and 120₂ residing on LAN 802, a storage node 106₁ residing on LAN 802, and one or more devices of a cloud-based storage service 114₁. The LAN 802 is connected to the Internet via edge device 816.

The VFS node 120₁ comprises client VMs 802₁ and 802₂, a VFS virtual machine 804, and a solid state drive (SSD) 806₁ used for tier 1 storage. One or more client processes run in each of the client VMs 802₁ and 802₂. Running in the VM 804 is one or more instances of each of the VFS front end 220, the VFS back end 222, and the VFS memory controller 224. The number of instances of the three VFS components running in the VM 804 may adapt dynamically based on, for example, demand on the virtual file system (e.g., number of pending file system operations, predicted future file system operations based on past operations, capacity, etc.) and resources available in the node(s) 120₁ and/or 120₂. Similarly, additional VMs 804 running VFS components may be dynamically created and destroyed as dictated by conditions (including, for example, demand on the virtual file system and demand for resources of the node(s) 120₁ and/or 120₂ by the client VMs 802₁ and 802₂).

The VFS node 120₂ comprises client processes 808₁ and 808₂, a VFS process 810, and a solid state drive (SSD) 806₂ used for tier 1 storage. The VFS process 810 implements one or more instances of each of the VFS front end 220, the VFS back end 222, and the VFS memory controller 224. The number of instances of the three VFS components implemented by the process 810 may adapt dynamically based on, for example, demand on the virtual file system (e.g., number of pending file system operations, predicted future file system operations based on past operations, capacity etc.) and resources available in the node(s) 120₁ and/or 120₂. Similarly, additional processes 810 running VFS components may be dynamically created and destroyed as dictated by conditions (including, for example, demand on the virtual file system and demand for resources of the node(s) 120₁ and/or 120₂ by the client processes 808₁ and 808₂).

The storage node 106₁ comprises one or more hard disk drives used for Tier 3 storage.

In operation, the VMs 802₁ and 802₂ issue file system calls to one or more VM front end instances running in the VM 804 in node 120₁, and the processes 808₁ and 808₂ issue file system calls to one or more VM front end instances implemented by the VFS process 810. The VFS front-end instances delegate file system operations to the VFS back end instances, where any VFS front end instance, regardless of whether it is running on node 120₁ and 120₂, may delegate a particular file system operation to any VFS back end instance, regardless of whether it is running on node 120₁ or 120₂. For any particular file system operation, the VFS back end instance(s) servicing the operation determine whether data affected by the operation resides in SSD 806₁, SSD 806₂, in storage node 106₁, and/or on storage service 114₁. For data stored on SSDs 806₁ the VFS back end instance(s) delegate the task of physically accessing the data to a VFS memory controller instance running in VFS VM 804. For data stored on SSDs 806₂ the VFS back end instance(s) delegate the task of physically accessing the data to a VFS memory controller instance implemented by VFS process 810. The VFS back end instances may access data stored on the node 106₁ using standard network storage protocols such as network file system (NFS) and/or server message block (SMB). The VFS back end instances may access data stored on the service 114₁ using standard network protocols such HTTP.

The virtual file system of FIG. 8B is implemented on a plurality of computing devices comprising two VFS nodes 120₁ and 120₂ residing on LAN 802, and two storage nodes 106₁ and 106₂ residing on LAN 802.

The VFS node 120₁ comprises client VMs 802₁ and 802₂, a VFS virtual machine 804, and a solid state drive (SSD) 806₁ used for tier 1 storage and an SSD 824₁ used for tier 2 storage. One or more client processes run in each of the client VMs 802₁ and 802₂. Running in the VM 804 is one or more instances of each of the VFS front end 220, the VFS back end 222, and the VFS memory controller 224.

The VFS node 120₂ comprises client processes 808₁ and 808₂, a VFS process 810, and a SSD 806₂ used for tier 1 storage, and a SSD 824₂ used for tier 2 storage. The VFS process 810 implements one or more instances of each of the VFS front end 220, the VFS back end 222, and the VFS memory controller 224.

The storage node 106₁ is as described with respect to FIG. 8A.

The storage node 106₂ comprises a virtual tape library used for Tier 4 storage (just one example of an inexpensive archiving solution, others include HDD based archival systems and electro-optic based archiving solutions). The VFS back end instances may access the storage node 106₂ using standard network protocols such as network file system (NFS) and/or server message block (SMB).

Operation of the system of FIG. 8B is similar to that of FIG. 8A, except archiving is done locally to node 1062 rather than the cloud-based service 114₁ in FIG. 8A.

The virtual file system of FIG. 8C is similar to the one shown in FIG. 8A, except tier 3 storage is handled by a second cloud-based service 114₂. The VFS back end instances may access data stored on the service 114₂ using standard network protocols such HTTP.

The virtual file system of FIG. 8D is implemented on a plurality of computing devices comprising two compute nodes 104₁ and 104₂ residing on LAN 802, three VFS nodes 120₁-120₃ residing on the LAN 802, and a tier 3 storage service 114₁ residing on cloud-based devices accessed via edge device 816. In the example system of FIG. 8D, the VFS nodes 120₂ and 120₃ are dedicated VFS nodes (no client processes running on them).

Two VMs 802 are running on each of the compute nodes 104₁, 104₂, and the VFS node 120₁. In the compute node 104₁, the VMs 802₁ and 802₂ issue file system calls to an NFS driver/interface 846, which implements the standard NFS protocol. In the compute node 104₂, the VMs 802₂ and 802₃ issue file system calls to an SMB driver/interface 848, which implements the standard SMB protocol. In the VFS node 120₁, the VMs 802₄ and 802₅ issue file system calls to an VFS driver/interface 850, which implements a proprietary protocol that provides performance gains over standard protocols when used with an implementation of the virtual file system described herein.

Residing on the VFS node 120₂ is a VFS front end instance 220₁ a VFS back end instance 222₁ a VFS memory controller instance 224₁ that carries out accesses to a SSD 806 used for tier 1 storage, and a HDD 852₁ used for tier 2 storage. Accesses to the HDD 852₁ may, for example, be carried out by a standard HDD driver or vendor-specific driver provided by a manufacturer of the HDD 852₁.

Running on the VFS node 120₃ are two VFS front end instances 220₂ and 220₃, VFS back end instances 222₂ and 222₃, a VFS memory controller instance 224₂, that carries out accesses a SSD 806 used for tier 1 storage, and a HDD 852₁ used for tier 2 storage. Accesses to the HDD 852₂ may, for example, be carried out by a standard HDD driver or vendor-specific driver provided by a manufacturer of the HDD 852₂.

The number of instances of the VFS front end and the VFS back end shown in FIG. 8D was chosen arbitrarily to illustrate that different numbers of VFS front end instances and VFS back end instances may run on different devices. Moreover, the number of VFS front ends and VFS back ends on any given device may be adjusted dynamically based on, for example, demand on the virtual file system.

In operation, the VMs 802₁ and 802₂ issue file system calls which the NFS driver 846 translates to messages adhering to the NFS protocol. The NFS messages are then handled by one or more of the VFS front end instances as described above (determining which of the VFS back end instance(s) 222₁-222₃ to delegate the file system call to, etc.) Similarly, the VMs 802₃ and 802₄ issue file system calls which the SMB driver 848 translates to messages adhering to the SMB protocol. The SMB messages are then handled by one or more of the VFS front end instances 220₁-220₃ as described above (determining which of the VFS back end instance(s) 222₁-222₃ to delegate the file system call to, etc.) Likewise, the VMs 802₄ and 802₅ issue file system calls which the VFS driver 850 translates to messages adhering to a proprietary protocol customized for the virtual file system. The VFS messages are then handled by one or more of the VFS front end instances 220₁-220₃ as described above (determining which of the VFS back end instance(s) 222₁-222₃ to delegate the file system call to, etc.)

For any particular file system call, one of VFS back end instances 222₁-222₃, servicing the call determines whether data to be accessed in servicing is stored on SSD 806₁, SSD 806₂, HDD 852₁, HDD 852₂, and/or on the service 114₁. For data stored on SSD 806₁, the VFS memory controller 224₁ is enlisted to access the data. For data stored on SSD 806₂, the VFS memory controller 224₂ is enlisted to access the data. For data stored on HDD 852₁, an HDD driver on the node 120₂ is enlisted to access the data. For data stored on HDD 852₂, an HDD driver on the node 120₃ is enlisted to access the data. For data on the service 114₁, the VFS back end may generate messages adhering to a protocol (e.g., HTTP) for accessing the data and send those messages to the service via edge device 816.

The virtual file system of FIG. 8E is implemented on a plurality of computing devices comprising two compute nodes 104₁ and 104₂ residing on LAN 802, and four VFS nodes 120₁-120₄ residing on the LAN 802. In the example system of FIG. 8E, the VFS node 120₂ is dedicated to running instances of VFS front end 220, the VFS node 120₃ is dedicated to running instances of VFS back end 222, and VFS node 120₄ comprises to running instances of VFS memory controller 224. The partitioning of the various components of the virtual file system as shown in FIG. 8E is just one possible partitioning. The modular nature of the virtual file system enables instances of the various components of the virtual file system to be portioned among devices in whatever manner makes best use of resources available and the demands imposed on any particular implementation of the virtual file system.

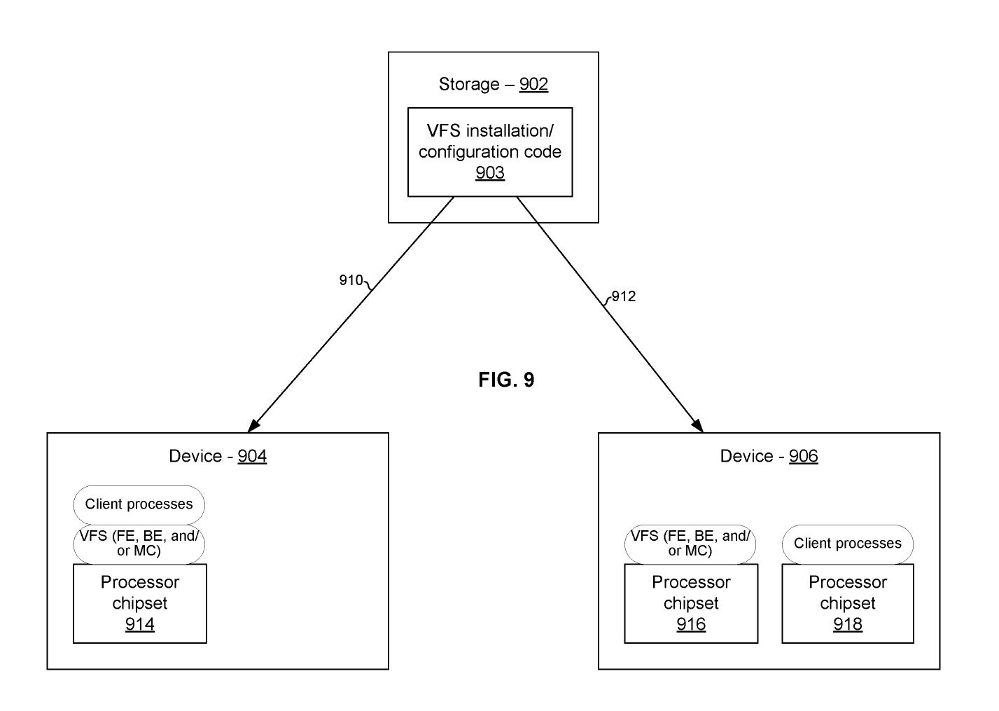

FIG. 9 is a block diagram illustrating configuration of a virtual file system from a non-transitory machine-readable storage. Shown in FIG. 9 is non-transitory storage 902 on which resides code 903. The code is made available to computing devices 904 and 906 (which may be compute nodes, VFS nodes, and/or dedicated storage nodes such as those discussed above) as indicated by arrows 910 and 912. For example, storage 902 may comprise one or more electronically addressed and/or mechanically addressed storage devices residing on one or more servers accessible via the Internet and the code 903 may be downloaded to the devices 904 and 906. As another example, storage 902 may be an optical disk or FLASH-based disk which can be connected to the computing devices 904 and 906 (e.g., via USB, SATA, PCIe, and/or the like).

When executed by a computing device such as 904 and 906, the code 903 may install and/or initialize one or more of the VFS driver, VFS front-end, VFS back-end, and/or VFS memory controller on the computing device. This may comprise copying some or all of the code 903 into local storage and/or memory of the computing device and beginning to execute the code 903 (launching one or more VFS processes) by one or more processors of the computing device. Which of code corresponding to the VFS driver, code corresponding to the VFS front-end, code corresponding to the VFS back-end, and/or code corresponding to the VFS memory controller is copied to local storage and/or memory and is executed by the computing device may be configured by a user during execution of the code 903 and/or by selecting which portion(s) of the code 903 to copy and/or launch. In the example shown, execution of the code 903 by the device 904 has resulted in one or more client processes and one or more VFS processes being launched on the processor chipset 914. That is, resources (processor cycles, memory, etc.) of the processor chipset 914 are shared among the client processes and the VFS processes. On the other hand, execution of the code 903 by the device 906 has resulted in one or more VFS processes launching on the processor chipset 916 and one or more client processes launching on the processor chipset 918. In this manner, the client processes do not have to share resources of the processor chipset 916 with the VGS process(es). The processor chipset 918 may comprise, for example, a process of a network adaptor of the device 906.

In accordance with an example implementation of this disclosure, a system comprises a plurality of computing devices that are interconnected via a local area network (e.g., 105, 106, and/or 120 of LAN 102) and that comprise circuitry (e.g., hardware 202, 302, and/or 402 configured by firmware and/or software 212, 216, 218, 220, 221, 222, 224, and/or 226) configured to implement a virtual file system comprising one or more instances of a virtual file system front end and one or more instances of a virtual file system back end. Each of the one or more instances of the virtual file system front end (e.g., 220₁) is configured to receive a file system call from a file system driver (e.g., 221) residing on the plurality of computing devices, and determine which of the one or more instances of the virtual file system back end (e.g., 222₁) is responsible for servicing the file system call. Each of the one or more instances of the virtual file system back end (e.g., 222₁) is configured to receive a file system call from the one or more instances of the virtual file system front end (e.g., 2200, and update file system metadata for data affected by the servicing of the file system call. The number of instances (e.g., W) in the one or more instances of the virtual file system front end, and the number of instances (e.g., X) in the one or more instances of the virtual file system back end are variable independently of each other. The system may further comprise a first electronically addressed nonvolatile storage device (e.g., 806₁) and a second electronically addressed nonvolatile storage device (806₂), and each instance of the virtual file system back end may be configured to allocate memory of the first electronically addressed nonvolatile storage device and the second electronically addressed nonvolatile storage device such that data written to the virtual file system is distributed (e.g., data written in a single file system call and/or in different file system calls) across the first electronically addressed nonvolatile storage device and the second electronically addressed nonvolatile storage device. The system may further comprise a third nonvolatile storage device (e.g., 106₁ or 824₁), wherein the first electronically addressed nonvolatile storage device and the second electronically addressed nonvolatile storage device are used for a first tier of storage, and the third nonvolatile storage device is used for a second tier of storage. Data written to the virtual file system may be first stored to the first tier of storage and then migrated to the second tier of storage according to policies of the virtual file system. The file system driver may support a virtual file system specific protocol, and at least one of the following legacy protocols: network file system protocol (NFS) and server message block (SMB) protocol.

In accordance with an example implementation of this disclosure, a system may comprise a plurality of computing devices (e.g., 105, 106, and/or 120 of LAN 102) that reside on a local area network (e.g., 102) and comprise a plurality of electronically addressed nonvolatile storage devices (e.g., 806₁ and 806₂). Circuitry of the plurality of computing devices (e.g., hardware 202, 302, and/or 402 configured by software 212, 216, 218, 220, 221, 222, 224, and/or 226) is configured to implement a virtual file system, where: data stored to the virtual file system is distributed across the plurality of electronically addressed nonvolatile storage devices, any particular quantum of data stored to the virtual file system is associated with an owning node and a storing node, the owning node is a first one of the computing devices and maintains metadata for the particular quantum of data; and the storing node is a second one of the computing devices comprising one of the electronically addressed nonvolatile storage devices on which the quantum of data physically resides. The virtual file system may comprise one or more instances of a virtual file system front end (e.g., 220₁ and 220₂), one or more instances of a virtual file system back end (e.g., 222₁ and 222₂), a first instance of a virtual file system memory controller (e.g., 224₁) configured to control accesses to a first of the plurality of electronically addressed nonvolatile storage devices, and a second instance of a virtual file system memory controller configured to control accesses to a second of the plurality of electronically addressed nonvolatile storage devices. Each instance of the virtual file system front end may be configured to: receive a file system call from a file system driver residing on the plurality of computing devices, determine which of the one or more instances of the virtual file system back end is responsible for servicing the file system call, and send one or more file system calls to the determined one or more instances of the plurality of virtual file system back end. Each instance of the virtual file system back end may be configured to: receive a file system call from the one or more instances of the virtual file system front end, and allocate memory of the plurality of electronically addressed nonvolatile storage devices to achieve the distribution of the data across the plurality of electronically addressed nonvolatile storage devices. Each instance of the virtual file system back end may be configured to: receive a file system call from the one or more instances of the virtual file system front end, and update file system metadata for data affected by the servicing of the file system call. Each instance of the virtual file system back end may be configured to generate resiliency information for data stored to the virtual file system, where the resiliency information can be used to recover the data in the event of a corruption. The number of instances in the one or more instances of the virtual file system front end may be dynamically adjustable based on demand on resources of the plurality of computing devices and/or dynamically adjustable independent of the number of instances (e.g., X) in the one or more instances of the virtual file system back end. The number of instances (e.g., X) in the one or more instances of the virtual file system back end may be dynamically adjustable based on demand on resources of the plurality of computing devices and/or dynamically adjustable independent of the number of instances in the one or more instances of the virtual file system front end. A first one or more of the plurality of electronically addressed nonvolatile storage devices may be used for a first tier of storage, and a second one or more of the plurality of electronically addressed nonvolatile storage devices may be used for a second tier of storage. The first one or more of the plurality of electronically addressed nonvolatile storage devices may be characterized by a first value of a latency metric and/or a first value of an endurance metric, and the second one or more of the plurality of electronically addressed nonvolatile storage devices may be characterized by a second value of the latency metric and/or a second value of the endurance metric. Data stored to the virtual file system may be distributed across the plurality of electronically addressed nonvolatile storage devices and one or more mechanically addressed nonvolatile storage devices (e.g., 106₁). The system may comprise one or more other nonvolatile storage devices (e.g., 114₁ and/or 114₂) residing on one or more other computing devices coupled to the local area network via the Internet. The plurality of electronically addressed nonvolatile storage devices may be used for a first tier of storage, and the one or more other storage devices may be used for a second tier of storage. Data written to the virtual file system may be first stored to the first tier of storage and then migrated to the second tier of storage according to policies of the virtual file system. The second tier of storage may be an object-based storage. The one or more other nonvolatile storage devices may comprise one or more mechanically addressed nonvolatile storage devices. The system may comprise a first one or more other nonvolatile storage devices residing on the local area network (e.g., 106₁), and a second one or more other nonvolatile storage devices residing on one or more other computing devices coupled to the local area network via the Internet (e.g., 114₁). The plurality of electronically addressed nonvolatile storage devices may be used for a first tier of storage and a second tier of storage, the first one or more other nonvolatile storage devices residing on the local area network may be used for a third tier of storage, and the second one or more other nonvolatile storage devices residing on one or more other computing devices coupled to the local area network via the Internet may be used for a fourth tier of storage. A client application and one or more components of the virtual file system may resides on a first one of the plurality of computing devices. The client application and the one or more components of the virtual file system may share resources of a processor of the first one of the plurality of computing devices. The client application may be implemented by a main processor chipset (e.g., 204) of the first one of the plurality of computing devices, and the one or more components of the virtual file system may be implemented by a processor of a network adaptor (e.g., 208) of the first one of the plurality of computing devices. File system calls from the client application may be handled by a virtual file system front end instance residing on a second one of the plurality of computing devices.

Thus, the present methods and systems may be realized in hardware, software, or a combination of hardware and software. The present methods and/or systems may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip. Some implementations may comprise a non-transitory machine-readable medium (e.g., FLASH drive(s), optical disk(s), magnetic storage disk(s), and/or the like) having stored thereon one or more lines of code executable by a computing device, thereby configuring the machine to be configured to implement one or more aspects of the virtual file system described herein.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise first “circuitry” when executing a first one or more lines of code and may comprise second “circuitry” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.).

What is claimed is:

1-30. (canceled)

31. A system comprising:
a plurality of computing devices that are interconnected via a local area network, the circuitry of the plurality of computing devices configured to implement a virtual file system comprising one or more instances of a virtual file system front end and one or more instances of a virtual file system back end, wherein:
each of the one or more instances of the virtual file system front end is configured to:
receive a file system call from a virtual file system driver residing on the plurality of computing devices; and
determine which of the one or more instances of the virtual file system back end is responsible for servicing the file system call;
each of the one or more instances of the virtual file system back end is configured to:
receive a file system call from the one or more instances of the virtual file system front end; and
update file system metadata for data affected by the servicing of the file system call; and
the number of instances in the one or more instances of the virtual file system front end and the number of instances in the one or more instances of the virtual file system back end are variable independently of each other.

32. The system of claim 31, comprising a first electronically addressed nonvolatile storage device and a second electronically addressed nonvolatile storage device, wherein each instance of the virtual file system back end is configured to:
allocate memory of the first electronically addressed nonvolatile storage device and the second electronically addressed nonvolatile storage device such that data written to the virtual file system is distributed across the first electronically addressed nonvolatile storage device and the second electronically addressed nonvolatile storage device.

33. The system of claim 32, comprising a third nonvolatile storage device, wherein:
the first electronically addressed nonvolatile storage device and the second electronically addressed nonvolatile storage device are used for a first tier of storage; and
the third nonvolatile storage device is used for a second tier of storage.

34. The system of claim 33, wherein data written to the virtual file system is first stored to the first tier of storage and then migrated to the second tier of storage according to policies of the virtual file system.

35. The system of claim 31, wherein the virtual file system driver supports a virtual file system specific protocol, and at least one of the following legacy protocols: network file system protocol (NFS) and server message block (SMB) protocol.

36. A system comprising:
a plurality of computing devices that reside on a local area network and that comprise a plurality of electronically addressed nonvolatile storage devices, wherein:
circuitry of the plurality of computing devices is configured to implement a virtual file system;
data stored to the virtual file system is distributed across the plurality of electronically addressed nonvolatile storage devices;
any particular quantum of data stored to the virtual file system is associated with an owning node and a storing node;
the owning node is a first one of the computing devices and maintains metadata for the particular quantum of data; and
the storing node is a second one of the computing devices comprising one of the electronically addressed nonvolatile storage devices on which the quantum of data physically resides.

37. The system of claim 36, wherein the virtual file system comprises one or more instances of a virtual file system front end, one or more instances of a virtual file system back end, a first instance of a virtual file system memory controller configured to control accesses to a first of the plurality of electronically addressed nonvolatile storage devices, and a second instance of a virtual file system memory controller configured to control accesses to a second of the plurality of electronically addressed nonvolatile storage devices.

38. The system of claim 37, wherein each instance of the virtual file system front end is configured to:
receive a file system call from a virtual file system driver residing on the plurality of computing devices;
determine which of the one or more instances of the virtual file system back end is responsible for servicing the file system call; and
send one or more file system calls to the determined one or more instances of the plurality of virtual file system back end.

39. The system of claim 37, wherein each instance of the virtual file system back end is configured to:
receive a file system call from the one or more instances of the virtual file system front end; and
allocate memory of the plurality of electronically addressed nonvolatile storage devices to achieve the distribution of the data across the plurality of electronically addressed nonvolatile storage devices.

40. The system of claim 37, wherein each instance of the virtual file system back end is configured to:
receive a file system call from the one or more instances of the virtual file system front end; and
update file system metadata for data affected by the servicing of the file system call.

41. The system of claim 47, wherein:
each instance of the virtual file system back end is configured to generate resiliency information for data stored to the virtual file system; and
the resiliency information can be used to recover the data in the event of a corruption.

42. The system of claim 47, wherein:
the number of instances in the one or more instances of the virtual file system front end is dynamically adjustable based on demand on resources of the plurality of computing devices; and
the number of instances in the one or more instances of the virtual file system back end is dynamically adjustable based on demand on resources of the plurality of computing devices.

43. The system of claim 47, wherein:
the number of instances in the one or more instances of the virtual file system front end is dynamically adjustable independent of the number of instances in the one or more instances of the virtual file system back end; and
the number of instances in the one or more instances of the virtual file system back end is dynamically adjustable independent of the number of instances in the one or more instances of the virtual file system front end.

44. The system of claim 47, wherein:
a first one or more of the plurality of electronically addressed nonvolatile storage devices are used for a first tier of storage; and
a second one or more of the plurality of electronically addressed nonvolatile storage devices are used for a second tier of storage.

45. The system of claim 44, wherein:
the first one or more of the plurality of electronically addressed nonvolatile storage devices are characterized by a first value of a latency metric; and
the second one or more of the plurality of electronically addressed nonvolatile storage devices are characterized by a second value of the latency metric.

46. The system of claim 44, wherein:
the first one or more of the plurality of electronically addressed nonvolatile storage devices are characterized by a first value of an endurance metric; and
the second one or more of the plurality of electronically addressed nonvolatile storage devices are characterized by a second value of the endurance metric.

47. The system of claim 46, wherein data written to the virtual file system is first stored to the first tier of storage and then migrated to the second tier of storage according to policies of the virtual file system.

48. The system of claim 36, comprising one or more mechanically addressed nonvolatile storage device, wherein the data stored to the virtual file system is distributed across the plurality of electronically addressed nonvolatile storage devices and one or more mechanically addressed nonvolatile storage devices.

49. The system of claim 36, comprising one or more other nonvolatile storage devices residing on one or more other computing devices coupled to the local area network via the Internet.

50. The system of claim 49, wherein:
the plurality of electronically addressed nonvolatile storage devices are used for a first tier of storage; and
the one or more other storage devices are used for a second tier of storage.

51. The system of claim 50, wherein data written to the virtual file system is first stored to the first tier of storage and then migrated to the second tier of storage according to policies of the virtual file system.

52. The system of claim 50, wherein the second tier of storage is an object-based storage.

53. The system of claim 50, wherein the one or more other nonvolatile storage devices comprises one or more mechanically addressed nonvolatile storage devices.

54. The system of claim 36, comprising:
a first one or more other nonvolatile storage devices residing on the local area network; and
a second one or more other nonvolatile storage devices residing on one or more other computing devices coupled to the local area network via the Internet, wherein:
the plurality of electronically addressed nonvolatile storage devices are used for a first tier of storage and a second tier of storage;
the first one or more other nonvolatile storage devices residing on the local area network are used for a third tier of storage; and
the second one or more other nonvolatile storage devices residing on one or more other computing devices coupled to the local area network via the Internet are used for a fourth tier of storage.

55. The system of claim 36, wherein:
a client application resides on a first one of the plurality of computing devices; and
one or more components of the virtual file system reside on the first one of the plurality of computing devices.

56. The system of claim 55, wherein the client application and the one or more components of the virtual file system share resources of a processor of the first one of the plurality of computing devices.

57. The system of claim 55, wherein:
the client application is implemented by a main processor chipset of the first one of the plurality of computing devices; and
the one or more components of the virtual file system are implemented by a processor of a network adaptor of the first one of the plurality of computing devices.

58. The system of claim 53, wherein file system calls from the client application are handled by a virtual file system front end instance residing on a second one of the plurality of computing devices.

59. A non-transitory machine readable storage having code stored thereon, wherein:
when the code is executed by a first computing device, the first computing device is configured such that a single processor of the first computing device implements one or more components of a virtual file system and one or more client processes running on the first computing device; and
when the code is executed by a second computing device, the second computing device is configured such that a first processor of the second computing device implements the one or more components of a virtual file system, and a second processor of the second computing device implements one or more client processes running on the second computing device.

50. The non-transitory machine readable storage of claim 59, wherein the second processor is a processor of a network adaptor of the second computing device.
